(19) United States
(12) Patent Application Publication
(10) Pub. No.: US 2013/0265684 A1
(43) Pub. Date: Oct. 10, 2013

(54) SWITCHING CIRCUIT

(71) Applicant: SUMITOMO ELECTRIC INDUSTRIES, LTD., Osaka-shi (JP)

(72) Inventor: Kazuhiro Fujikawa, Osaka-shi (JP)

(73) Assignee: Sumitomo Electric Industries, Ltd., Osaka-shi (JP)

(21) Appl. No.: 13/830,064

(22) Filed: Mar. 14, 2013

Related U.S. Application Data
(60) Provisional application No. 61/621,245, filed on Apr. 6, 2012.

(30) Foreign Application Priority Data
Apr. 6, 2012 (JP) 2012-087110

(51) Int. Cl. H02H 3/08

(52) U.S. Cl. CPC H02H 3/08
USPC 361/87

(57) ABSTRACT

A switching circuit 1 comprises a transistor 11; a detection resistance 12, connected to the transistor 11, for receiving a current flowing through the transistor 11; an overcurrent detection circuit 13 for detecting from a voltage between both ends of the detection resistance 12 whether or not the current flowing through the transistor 11 is an overcurrent; a control circuit 15 for switching control of the transistor 11, the control circuit restricting the switching control when the overcurrent detection circuit 13 detects that the current flowing through the transistor 11 is the overcurrent; and a level-shift circuit 14, disposed between the overcurrent detection circuit 13 and the control circuit 15, for level-shifting a signal from the overcurrent detection circuit 13 and transmitting the level-shifted signal to the control circuit 15; the overcurrent detection circuit 13 having a ground potential different from that of the control circuit 15.

### CROSS-REFERENCE TO RELATED APPLICATION

This application claims priority to Provisional Application No. 61/621,245 filed on Apr. 6, 2012 and claims the benefit of Japanese Patent Application No. 2012-087110 filed on Apr. 6, 2012, all of which are incorporated herein by reference in their entirety.

### TECHNICAL FIELD

The present invention relates to a switching circuit for performing switching control of transistors.

### BACKGROUND

In a switching circuit for performing switching control of a transistor, it has been contrived to protect the transistor from falling into abnormal operation states (e.g., overcurrent, overvoltage, and high temperature). Japanese Patent Application Laid-Open No. 11-234896 discloses a switching circuit of this kind.

Specifically, Japanese Patent Application Laid-Open No. 11-234896 discloses a half-bridge switching circuit (inverter) which comprises two transistors 12a, 12b connected in series and amplifier circuits 21a, 14a for switching control of the transistors 12a, 12b, respectively, and alternately performs switching control of the transistors 12a, 12b.

The switching circuit comprises a detection resistance 21b connected between current sense and emitter terminals of the transistor 12a on the upper arm side, a comparator 21c which operates to output a signal when the voltage between both ends of the detection resistance 21b exceeds a predetermined value, a timer circuit 21d which operates to output a signal for a predetermined period from when the comparator 21c starts operating, and a gate-off circuit 21e for turning off the output of the amplifier circuit 21a during when the timer circuit 21d operates, and it is disclosed that the transistor 12a on the upper arm side is turned off when an overcurrent flows therein.

Similarly, the switching circuit comprises a detection resistance 14b connected between current sense and emitter terminals of the transistor 12b on the lower arm side, a comparator 14c which operates to output a signal when the voltage between both ends of the detection resistance 14b exceeds a predetermined value, and a gate-off circuit 14d for turning off the output of the amplifier circuit 14a when the comparator 14c operates, and it is disclosed that the transistor 12b on the lower arm side is turned off when an overcurrent flows therein.

### SUMMARY

Meanwhile, when a ground of an overcurrent protection circuit (corresponding to an overcurrent detection circuit of the present invention) constituted by the comparator 21c, timer circuit 21d, and gate-off circuit 21e and a ground of the amplifier circuit (corresponding to a control circuit of the present invention) 21a are used in common, switching noises of the amplifier circuit 21a enter the overcurrent protection circuit 21c to 21e through the common ground.

Also, a closed loop connecting the overcurrent protection circuit 21c to 21e, the common ground of the overcurrent protection circuit 21c to 21e and amplifier circuit 21a, the emitter terminal of the transistor 12a, the detection resistance 21b, and the overcurrent protection circuit 21c to 21e in sequence is formed, and a loop current induced by switching noises of the transistor 12a flows through the closed loop. This loop current allows the switching noises of the transistor 12a to enter the overcurrent protection circuit 21c to 21e.

These switching noises of the transistor 12a and amplifier circuit 21a may cause the overcurrent protection circuit 21c to 21e to malfunction.

Similarly, when a ground of an overcurrent protection circuit (corresponding to the overcurrent detection circuit of the present invention) constituted by the comparator 14c and gate-off circuit 14d and a ground of the amplifier circuit (corresponding to a control circuit of the present invention) 14d are used in common, switching noises of the amplifier circuit 14a enter the overcurrent protection circuit 14c, 14d through the common ground.

Also, a closed loop connecting the overcurrent protection circuit 14c, 14d, the common ground of the overcurrent protection circuit 14c, 14d and amplifier circuit 14a, the emitter terminal of the transistor 12b, the detection resistance 14b, and the overcurrent protection circuit 14c, 14d in sequence is formed, and a loop current induced by switching noises of the transistor 12b flows through the closed loop. This loop current allows the switching noises of the transistor 12b to enter the overcurrent protection circuit 14c, 14d.

These switching noises of the transistor 12b and amplifier circuit 14a may cause the overcurrent protection circuit 14c, 14d to malfunction.

It is therefore an object of the present invention to provide a switching circuit which can inhibit switching noises of transistors and driving control circuits from causing an overcurrent detection circuit to malfunction.

In one aspect, the present invention provides a switching circuit comprising a transistor; a detection resistance, connected to the transistor, for receiving a current flowing through the transistor or a current related to the flowing current; an overcurrent detection circuit for detecting from a voltage between both ends of the detection resistance whether or not the current flowing through the transistor is an overcurrent; a control circuit for switching control of the transistor, the control circuit restricting the switching control when the overcurrent detection circuit detects that the current flowing through the transistor is the overcurrent; and a level-shift circuit, disposed between the overcurrent detection circuit and the control circuit, for level-shifting a signal from the overcurrent detection circuit and transmitting the level-shifted signal to the control circuit; the overcurrent detection circuit having a ground potential different from that of the control circuit.

In this switching circuit, a level-shift circuit is inserted between an overcurrent detection circuit and a control circuit, while the ground potential of the overcurrent detection circuit differs from that of the control circuit, whereby switching noises for driving a transistor in the control circuit can be prevented from entering the overcurrent detection circuit through the ground.

This can prevent the overcurrent detection circuit, control circuit, transistor, and detection resistance from forming a closed loop through the ground of the overcurrent detection circuit and the ground of the control circuit and prohibit loop currents induced by the switching noises of the transistor from occurring. As a result, the switching noises of the transistor can be prevented from entering the overcurrent detection circuit.

This can inhibit the switching noises of the transistor and driving control circuit from causing the overcurrent detection circuit to malfunction.

In another aspect, the present invention provides a half-bridge switching circuit having first and second transistors sequentially connected in series between higher and lower potentials; the switching circuit comprising a first detection resistance, connected to the first transistor, for receiving a current flowing through the first transistor or a current related to the flowing current; a first overcurrent detection circuit for detecting from a voltage between both ends of the first detection resistance whether or not the current flowing through the first transistor is an overcurrent; a first control circuit for switching control of the first transistor, the first control circuit restricting the switching control when the first overcurrent detection circuit detects that the current flowing through the first transistor is the overcurrent; a second detection resistance, connected to the second transistor, for receiving a current flowing through the second transistor or a current related to the flowing current; a second overcurrent detection circuit for detecting from a voltage between both ends of the second detection resistance whether or not the current flowing through the second transistor is an overcurrent; a second control circuit for switching control of the second transistor, the second control circuit restricting the switching control when the second overcurrent detection circuit detects that the current flowing through the second transistor is the overcurrent; and a level-shift circuit, disposed between the first overcurrent detection circuit and the first control circuit, for level-shifting a signal from the first overcurrent detection circuit and transmitting the level-shifted signal to the first control circuit; the first overcurrent detection circuit having a ground potential different from that of the first control circuit.

In this half-bridge switching circuit, a level-shift circuit is inserted between the first overcurrent detection circuit and first control circuit on the upper arm side, while the ground potential of the first overcurrent detection circuit differs from that of the first control circuit, whereby switching noises for driving the first transistor in the first control circuit can be prevented from entering the first overcurrent detection circuit through the ground.

This can prevent the first overcurrent detection circuit, first control circuit, first transistor, and first detection resistance from forming a closed loop through the ground of the first overcurrent detection circuit and the ground of the first control circuit and prohibit loop currents induced by the switching noises of the first transistor from occurring. As a result, the switching noises of the first transistor can be prevented from entering the first overcurrent detection circuit.

This can inhibit the switching noises of the first transistor and driving control circuit from causing the first overcurrent detection circuit to malfunction.

Meanwhile, in the half-bridge switching circuit described in Japanese Patent Application Laid-Open No. 11-234896, switching of the transistors 12a, 12b causes a common-mode voltage therebetween to fluctuate, and the resulting common-mode voltage fluctuation enters the overcurrent protection circuit 21c to 21e through the detection resistance 21b on the upper arm side. This common-mode voltage fluctuation may provoke the overcurrent protection circuit 21c to 21e on the upper arm side in particular to malfunction.

It is therefore preferred in the switching circuit in accordance with the present invention that the first transistor have a source or emitter terminal connected to a drain or collector terminal of the second transistor and that the first detection resistance be inserted between the drain or collector terminal of the first transistor and the higher potential.

Since the first detection resistance on the upper arm side is inserted between the drain or collector terminal of the first transistor and the higher potential, this structure can prevent the common-mode voltage fluctuation on the source or emitter terminal side of the first transistor from entering the first overcurrent detection circuit. This can inhibit the common-mode voltage fluctuation from causing the first overcurrent detection circuit on the upper arm side to malfunction.

Preferably, in the switching circuit in accordance with the present invention, the ground potential of the first control circuit is the potential of the source or emitter terminal of the first transistor, and the ground potential of the first overcurrent detection circuit is the higher potential.

Since the ground potential of the first overcurrent detection circuit on the upper arm side is a stable potential, this structure can more strongly inhibit the first overcurrent detection circuit on the upper arm side from malfunctioning.

Preferably, in the switching circuit in accordance with the present invention, the level-shift circuit is a photocoupler.

Since the level-shift circuit can electrically insulate the control circuit and the overcurrent detection circuit from each other, this structure can more strongly prevent switching noises for driving the transistor in the control circuit from entering the overcurrent detection circuit. It can also more strongly prevent the overcurrent detection circuit, control circuit, transistor, and detection resistance from forming a closed loop through the ground of the overcurrent detection circuit and the ground of the control circuit and prohibit the switching noises of the transistor from entering the overcurrent detection circuit. This can more strongly inhibit the switching noises of the transistor and driving control circuit from causing the overcurrent detection circuit to malfunction.

The present invention can inhibit, in a switching circuit for switching control of a transistor, switching noises of the transistor and driving control circuits from causing an overcurrent detection circuit for protecting the transistor to malfunction.

### BRIEF DESCRIPTION OF THE DRAWINGS

FIG. 1 is a circuit diagram illustrating the switching circuit in accordance with an embodiment of the present invention.

### DETAILED DESCRIPTION

In the following, preferred embodiments of the present invention will be explained in detail with reference to the drawing. The same or equivalent parts in the drawing will be referred to with the same signs.

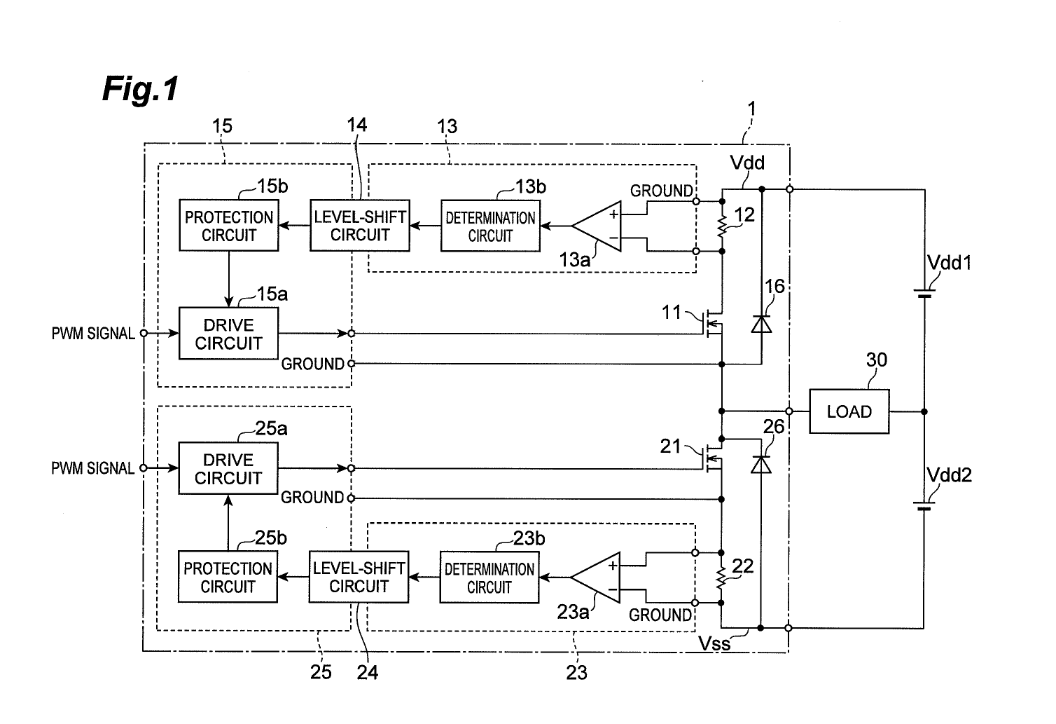

FIG. 1 is a circuit diagram illustrating the switching circuit in accordance with an embodiment of the present invention. The switching circuit 1 illustrated in FIG. 1 is a half-bridge switching circuit (inverter) in which first and second transistors 11, 12 are sequentially connected in series between a higher potential Vdd and a lower potential Vss.

For switching control of the first transistor 11 on the upper arm side, the switching circuit 1 comprises a first detection resistance 12, a first overcurrent detection circuit 13, a first level-shift circuit 14, and a first control circuit 15. For switching control of the second transistor 21 on the lower arm side, the switching circuit 1 comprises a second detection resistance 22, a second overcurrent detection circuit 23, a second level-shift circuit 24, and a second control circuit 25.

For example, each of the first and second transistors 11, 21 is an N-channel FET (Field Effect Transistor). While the source terminal of the first transistor 11 and the drain terminal of the second transistor 21 are connected to each other, the first and second transistors 11, 21 are connected in series between the higher potential Vdd and lower potential Vss. Diodes 16, 26 are connected in parallel to the first and second transistors 11, 21, respectively. Specifically, the diode 16 has an anode connected to the source terminal of the first transistor 11 and a cathode connected to the higher voltage Vdd. The diode 26 has an anode connected to the lower potential Vdd and a cathode connected to the drain terminal of the second transistor 21. Here, a load 30 is connected to a connection node between the source terminal of the first transistor 11 and the drain terminal of the second transistor 21.

The first detection resistance 12 is inserted between the drain terminal of the first transistor 11 and the higher potential Vdd. Since the first detection resistance 12 is thus connected in series to the first transistor 11, a voltage corresponding to the current flowing through the first transistor 11 occurs between both ends of the first detection resistance 12.

From the voltage between both ends of the first detection resistance 12, the first overcurrent detection circuit 13 detects whether or not the current flowing through the first transistor 11 is an overcurrent. The first overcurrent detection circuit 13 comprises a first comparator 13a and a first determination circuit 13b. When the voltage between both ends of the first detection resistance 12 exceeds a predetermined value, the first comparator 13 a changes its output signal level. When the signal level from the first comparator 13a is changed, the first determination circuit 13b determines that the current flowing through the first transistor 11 is the overcurrent. The ground potential of the first comparator 13a and first determination circuit 13b, i.e., the ground potential of the first overcurrent detection circuit 13, is the higher potential Vdd.

The first level-shift circuit 14 level-shifts a signal from the first overcurrent detection circuit 13 and transmits the level-shifted signal to the first control circuit 15. Specifically, the first level-shift circuit 14 shifts the signal level based on the ground potential of the first overcurrent detection circuit 13 to a signal level based on the ground potential of the first control circuit 15. For example, a photocoupler can be employed for the first level-shift circuit 14.

The first control circuit 15 performs switching control and overcurrent protection for the first transistor 11. The first control circuit 15 comprises a first drive circuit 15a and a first protection circuit 15b. The first drive circuit 15a performs switching control of the first transistor 11 according to a PWM signal. When the first overcurrent detection circuit 13 determines that the first transistor 11 is in the overcurrent state, the first protection circuit 15b inhibits the first drive circuit 15a from performing the switching control. For example, the first protection circuit 15b stops the first drive circuit 15a from performing the switching control. The ground potential of the first drive circuit 15a and first protection circuit 15b, i.e., the ground potential of the first control circuit 15, is the potential of the source terminal of the first transistor 11. That is, the ground potential of the first control circuit 15 and the ground potential of the first overcurrent detection circuit 13 differ from each other.

The second detection resistance 22 is inserted between the source terminal of the second transistor 21 and the lower potential Vss. Since the second detection resistance 22 is thus connected in series to the second transistor 21, a voltage corresponding to the current flowing through the second transistor 21 occurs between both ends of the second detection resistance 22.

From the voltage between both ends of the second detection resistance 22, the second overcurrent detection circuit 23 detects whether or not the current flowing through the second transistor 21 is an overcurrent. The second overcurrent detection circuit 23 comprises a second comparator 23a and a second determination circuit 23b. When the voltage between both ends of the second detection resistance 22 exceeds a predetermined value, the second comparator 23a changes its output signal level. When the signal level from the second comparator 23a is changed, the second determination circuit 23b determines that the current flowing through the second transistor 21 is the overcurrent. The ground potential of the second comparator 23a and second determination circuit 23b, i.e., the ground potential of the second overcurrent detection circuit 23, is the lower potential Vss.

The second level-shift circuit 24 level-shifts a signal from the second overcurrent detection circuit 23 and transmits the level-shifted signal to the first control circuit 25. Specifically, the second level-shift circuit 24 shifts the signal level based on the ground potential of the second overcurrent detection circuit 23 to a signal level based on the ground potential of the second control circuit 25. For example, a photocoupler can be employed for the second level-shift circuit 24.

The second control circuit 25 performs switching control and overcurrent protection for the second transistor 21. The second control circuit 25 comprises a second drive circuit 25a and a second protection circuit 25b. The second drive circuit 25a performs switching control of the first transistor 21 according to a PWM signal. When the second overcurrent detection circuit 23 determines that the second transistor 21 is in the overcurrent state, the second protection circuit 25b inhibits the second drive circuit 25a from performing the switching control. For example, the second protection circuit 25b stops the second drive circuit 25a from performing the switching control. The ground potential of the second drive circuit 25a and second protection circuit 25b, i.e., the ground potential of the second control circuit 25, is the potential of the source terminal of the second transistor 21. That is, the ground potential of the second control circuit 25 and the ground potential of the second overcurrent detection circuit 23 differ from each other.

On the upper arm side, the first level-shift circuit 14 is inserted between the first overcurrent detection circuit 13 and first control circuit 15, while the ground potential of the first overcurrent detection circuit 13 differs from that of the first control circuit 15, whereby the half-bridge switching circuit 1 can prevent switching noises of the first drive circuit 15a in the first control circuit 15 from entering the first overcurrent detection circuit 13 through the ground.

It can also prevent the first overcurrent detection circuit 13, first control circuit 15, first transistor 11, and first detection resistance 12 from forming a closed loop through the ground of the first overcurrent detection circuit 13 and the ground of the first control circuit 15 and prohibit loop currents induced by the switching noises of the first transistor 11 from occurring. As a result, the switching noises of the first transistor 11 can be prevented from entering the first overcurrent detection circuit 13.

This can inhibit the switching noises of the first transistor 11 and switching noises of the first drive circuit 15a in the first control circuit 15 from causing the first overcurrent detection circuit 13 to malfunction.

Since the first level-shift circuit 14 can electrically insulate the first control circuit 15 and the first overcurrent detection circuit 13 from each other, the half-bridge switching circuit 1 can more strongly prevent the switching noises of the first drive circuit 15a in the first control circuit 15 from entering the first overcurrent detection circuit 13. It can also more strongly prevent the first overcurrent detection circuit 13, first control circuit 15, first transistor 11, and first detection resistance 12 from forming a closed loop through the ground of the first overcurrent detection circuit 13 and the ground of the first control circuit 15 and prohibit the switching noises of the first transistor 11 from entering the first overcurrent detection circuit 13. This can more strongly inhibit the switching noises of the first transistor 11 and the switching noises of the first drive circuit 15a in the first control circuit 15 from causing the first overcurrent detection circuit 13 to malfunction.

Similarly, on the lower arm side, the second level-shift circuit 24 is inserted between the second overcurrent detection circuit 23 and second control circuit 25, while the ground potential of the second overcurrent detection circuit 23 differs from that of the second control circuit 25, whereby the half-bridge switching circuit 1 can prevent switching noises of the second drive circuit 25a in the second control circuit 25 from entering the second overcurrent detection circuit 23 through the ground.

It can also prevent the second overcurrent detection circuit 23, second control circuit 25, second transistor 21, and second detection resistance 22 from forming a closed loop through the ground of the second overcurrent detection circuit 23 and the ground of the second control circuit 25 and prohibit loop currents induced by the switching noises of the second transistor 21 from occurring. As a result, the switching noises of the second transistor 21 can be prevented from entering the second overcurrent detection circuit 23.

This can inhibit the switching noises of the second transistor 21 and switching noises of the second drive circuit 25a in the second control circuit 25 from causing the second overcurrent detection circuit 23 to malfunction.

Since the second level-shift circuit 24 can electrically insulate the second control circuit 25 and the second overcurrent detection circuit 23 from each other, the half-bridge switching circuit 1 can more strongly prevent the switching noises of the second drive circuit 25a in the second control circuit 25 from entering the second overcurrent detection circuit 23. It can also more strongly prevent the second overcurrent detection circuit 23, second control circuit 25, second transistor 21, and second detection resistance 22 from forming a closed loop through the ground of the second overcurrent detection circuit 23 and the ground of the second control circuit 25 and prohibit loop currents induced by switching noises of the second 21 from occurring. This can more strongly inhibit the switching noises of the second transistor 21 and the switching noises of the second drive circuit 25a in the second control circuit 25 from causing the second overcurrent detection circuit 23 to malfunction.

Since the first detection resistance 12 on the upper arm side is inserted between the drain terminal of the first transistor 11 and the higher voltage Vdd, the half-bridge switching circuit 1 can prevent the common-mode voltage fluctuation between the first and second transistors 11, 21 caused by their switching from entering the first overcurrent detection circuit 13 through the detection resistance 12. This can inhibit the common-mode voltage fluctuation from causing the first overcurrent detection circuit 13 on the upper arm side to malfunction.

Since the ground potential of the first overcurrent detection circuit 13 on the upper arm side is the stable potential Vdd, the half-bridge switching circuit 1 can more strongly inhibit the first overcurrent detection circuit 13 on the upper arm side from malfunctioning.

The present invention can be modified in various ways without being restricted to the above-mentioned embodiment. For example, though the embodiment illustrates a mode in which both of the upper and lower arm sides are provided with the level-shift circuits 14, 24, while the control circuits 15, 25 have a ground potential different from that of the overcurrent detection circuits 13, 23, at least the upper arm side alone may be provided with the level-shift circuit 14, while the control circuit 15 has a ground potential different from that of the overcurrent detection circuit 13.

Though the embodiment shows an insulated photocoupler as an example of the first and second level-shift circuits 14, 24, various types of level-shift circuits can be employed for the first and second level-shift circuits.

Though the embodiment shows an N-channel FET as an example of the first and second transistors 11, 21, various types of transistors such as IGBT (Insulated Gate Bipolar Transistor) and bipolar transistors can be employed for the first and second transistors 11, 21. When the IGBT is employed, the first and second detection resistances 12, 22 may be connected to respective current sense terminals of the first and second transistors 11, 21. In this case, currents related to the currents flowing through the first and second transistors 11, 21 flow through the first and second detection resistances 12, 22.

What is claimed is:

1. A switching circuit comprising:
a transistor;
a detection resistance, connected to the transistor, for receiving a current flowing through the transistor or a current related to the flowing current;
an overcurrent detection circuit for detecting from a voltage between both ends of the detection resistance whether or not the current flowing through the transistor is an overcurrent;
a control circuit for switching control of the transistor, the control circuit restricting the switching control when the overcurrent detection circuit detects that the current flowing through the transistor is the overcurrent; and
a level-shift circuit, disposed between the overcurrent detection circuit and the control circuit, for level-shifting a signal from the overcurrent detection circuit and transmitting the level-shifted signal to the control circuit;
wherein the overcurrent detection circuit has a ground potential different from that of the control circuit.

2. A half-bridge switching circuit having first and second transistors sequentially connected in series between higher and lower potentials, the switching circuit comprising:
a first detection resistance, connected to the first transistor, for receiving a current flowing through the first transistor or a current related to the flowing current;
a first overcurrent detection circuit for detecting from a voltage between both ends of the first detection resistance whether or not the current flowing through the first transistor is an overcurrent;
a first control circuit for switching control of the first transistor, the first control circuit restricting the switching control when the first overcurrent detection circuit detects that the current flowing through the first transistor is the overcurrent;
a second detection resistance, connected to the second transistor, for receiving a current flowing through the second transistor or a current related to the flowing current;
a second overcurrent detection circuit for detecting from a voltage between both ends of the second detection resistance whether or not the current flowing through the second transistor is an overcurrent;
a second control circuit for switching control of the second transistor, the second control circuit restricting the switching control when the second overcurrent detection circuit detects that the current flowing through the second transistor is the overcurrent; and
a level-shift circuit, disposed between the first overcurrent detection circuit and the first control circuit, for level-shifting a signal from the first overcurrent detection circuit and transmitting the level-shifted signal to the first control circuit;
wherein the first overcurrent detection circuit has a ground potential different from that of the first control circuit.

3. The switching circuit according to claim 2, wherein the first transistor has a source or emitter terminal connected to a drain or collector terminal of the second transistor; and
wherein the first detection resistance is inserted between the drain or collector terminal of the first transistor and the higher potential.

4. The switching circuit according to claim 3, wherein the ground potential of the first control circuit is the potential of the source or emitter terminal of the first transistor; and
wherein the ground potential of the first overcurrent detection circuit is the higher potential.

5. The switching circuit according to claim 1, wherein the level-shift circuit is a photocoupler.

6. The switching circuit according to claim 2, wherein the level-shift circuit is a photocoupler.
